(19) United States
(12) Patent Application Publication
(10) Pub. No.: US 2026/0351207 A1
(43) Pub. Date: Nov. 5, 2026

(54) DISPLAY DEVICE AND VEHICLE

(71) Applicant: MERCEDES-BENZ GROUP AG, Stuttgart (DE)

(72) Inventors: Benjamin AXMANN, Schömberg (DE); Jens DROTH, Leonberg (DE); Jürgen GAUGELE, Denkendorf (DE); Achim PROSS, Nagold (DE)

(21) Appl. No.: 19/484,590

(22) PCT Filed: Apr. 26, 2024
(86) PCT No.: PCT/EP2024/061597

§ 371 Date: Nov. 14, 2025

(30) Foreign Application Priority Data
May 15, 2023 (DE) 10 2023 001 982.8

(51) Int. Cl. G09G 3/34; B60K 35/22; B60K 35/81

(52) U.S. Cl. CPC G09G 3/3426; B60K 35/22; B60K 35/81; B60K 2360/343; G09G 2320/0626; G09G 2320/0686; G09G 2380/10

(57) ABSTRACT

A display device has a display surface with pixel elements and light elements. The light elements are arranged behind the pixel elements from a viewing direction towards the display surface to backlight the pixel elements or the light elements are formed by the pixel elements themselves. A control unit controls the pixel elements and light elements by dividing the display surface divided into at least two separate display areas and by individually changing the brightness of the display areas.

### BACKGROUND AND SUMMARY OF THE INVENTION

Exemplary embodiments of the invention relate to a display device and to a vehicle having such a display device.

Display devices, such as displays, are indispensable to everyday life. Display devices are used to represent information and are integrated into a wide variety of different devices, such as, for example, in smartwatches, smartphones, computer screens, televisions, display panels and similar. Now, even curved display devices are known. Display devices are also used in vehicles, for example as a display for the instrument cluster or in the form of a touch-sensitive display device to form a human-machine interface. For instance, the infotainment system of the vehicle can be operated via a head unit comprising a touch display.

The resolution of modern display devices is comparatively high, meaning that different image content can be displayed side by side even in a small space. For example, US 2023/0030288 A1 describes a display device integrated into a vehicle and divided into several display surfaces. The display surfaces are arranged vertically one above the other, for example. In a first display surface, for example, media content, such as a film, is presented or vehicle navigation is shown, and in a second display surface, the video stream recorded live with a vehicle exterior camera is displayed. The vehicle exterior camera can thus function as a virtual side mirror.

It is known to make the brightness of display devices adjustable. This enables them to adapt to the prevailing external lighting conditions. When viewing the display device in bright surroundings, such as for example outside with the sun shining, the brightness is increased so that the image content can be well perceived even in the bright surroundings. In order to prevent dazzling the viewer in dark surroundings, the brightness is reduced. The brightness of the display device can be automatically regulated with the aid of a light sensor, or manually with the aid, for example, of a slider controller displayed on the display device.

Setting an appropriate screen brightness is relevant to safety in particular for vehicle applications. In particular in adverse lighting conditions, such as heavy cloud, fog or at night, it has to be ensured that a person driving the vehicle is not restricted or prevented from safely driving the vehicle by the light emitted from display devices installed in the vehicle.

Exemplary embodiments present invention are directed to an improved display device, which makes driving a vehicle safer.

A generic display device, comprising a display surface, a plurality of pixel elements arranged inside the display surface, a plurality of light elements arranged inside the display surface, wherein the light elements are arranged behind the pixel elements from a viewing direction towards the display surface to backlight the pixel elements or the light elements are formed by the pixel elements themselves, and a control unit to control the pixel elements and light elements, wherein the display surface can be divided into at least two separate display areas, has been developed according to the invention in that the control unit is set up to individually change the brightness of the display areas by individually controlling each light element.

The display surface represents a contiguous surface in which the representation of image content is possible. The pixel elements and light elements are arranged inside the display surface. The pixel elements can be self-luminous, for example when designed as Organic Light Emitting Diodes (OLED) or MicroLEDs. The pixel elements can, however, also be backlit with the aid of a so-called backlight. In this case, the display device can be designed as an LCD display, for example. A respective pixel element can be switched between a state that is transmissive to light and a state that blocks light to form a monochromatic display. A respective pixel element can contain any number of subpixels and one or more color filters. For example, each pixel element can contain a red, green and blue subpixel. In this way, color displays can be realized.

The different display areas can be identical in size or different in size. If the display surface is divided into two display areas for example, both display areas can occupy 50% of the display surface, for example. However, it would also be possible for a first display area to occupy 70% and a second display area to occupy 30% of the display surface. Each display area is contiguous. Different display areas do not overlap on the display surface. In each display area, it is possible to represent different image content, in particular with another context. Each display area is at least larger than one single pixel, in order to utilize great degree of creative freedom when depicting abstract information.

According to the invention, the control unit is able to control each light element individually, so that it is possible to individually change the brightness in each display area. All common components, such as OLEDs, LEDs, MicroLEDs, electro-luminescence films, cold cathode tubes, and similar are eligible as light elements.

The control unit is able to change the brightness of the display areas depending on or independently of each other. If the brightness is changed independently, the brightness for each display area can be adjusted freely. If the brightness is changed in a dependent manner, the brightness of a second display area is chosen depending on the brightness set in a first display area. If the brightness is changed in the first display area, then the brightness is automatically changed in the second display area. For example, a proportional or anti-proportional change can take place, so that both display areas are brightened or dimmed, or one of the two display areas is brightened and the other is darkened.

In contrast to display devices known from the prior art, it is also possible to not only change the brightness of the entire display surface in one go, but also for each display area individually. This increases the scope to adapt the brightness, which enables the setting of a situation-specific, optimum brightness for comparatively large display devices. So, at any time, a good view of the displayed image content is possible in a respective ambient lighting situation, with further observers not being distracted by an appropriate brightness choice.

The display device can, for example, be viewed simultaneously by two users, with each user being assigned a display area. Then, an individual screen brightness can be set for each user. The respective screen brightness is adapted to the activities of the user. For example, the first user may perform a task in which they have to look at the display device from time to time to obtain relevant information. If they are not looking at the display device, they are focusing their attention on another task. Here, a comparatively dark brightness can be set. For example, the second user can mainly perceive image content displayed via the display device, for example watch a film. Then, a comparatively high brightness can be set for the second user. A high brightness could also be set for the first user and a low brightness for the second user if the first user is performing a safety-relevant task and must not be distracted by the film.

The division of the display surface can be designed to be fixed or variable, which will be discussed later.

An advantageous development of the display device provides that the control unit is set up to distribute the display areas that have different brightness on the display surface independently of image content to be played back on the display surface. The division of the display surface therefore takes place using a specified pattern. For example, the display surface can be divided vertically or horizontally into two rectangular display areas. Shape, size and brightness of the display areas then remain constant, at least for a time period, independently of the displayed image content. In particular, this represents a differentiation from what is known as “local dimming”, in which the backlight of a display is reduced in the areas in which dark screen content such as shadows or black are displayed. In contrast, with the display device according to the invention, the display surface is divided into several display areas following a fixed specification, wherein this division remains constant even over several “frames”, i.e., images played back on the display device.

In this case, the control unit is preferably set up to change the number and/or the distribution of the display areas having the different brightness. The division of the display surface into the different display areas can be static as explained above. For example, several light elements can be combined into groups, wherein the change in brightness is the same for all light elements of a group. The division of the display surface can then not be changed. However, it is preferably possible to perform the division of the display surface in a variable manner. For this purpose, the control unit is able to individually control each light element. This makes it possible to redivide the display surface into different display areas while the display device is being used. In this case, both the number of display areas can be changed, i.e., for example now three or four display areas can be displayed instead of two. Accordingly, an individual light adjustment is made for each display area. Additionally or alternatively, the shape of the display areas can be changed. For example, two square display areas can be displayed horizontally next to each other and after a change, a rectangular display area running over the entire surface of the display surface can be displayed, from which, for example, a circular or star-shaped area is cut out, which forms the second display area. This even further increases the creative freedom for displaying information and adapting the brightness by means of the display device according to the invention.

The division of the display surface into the respective display areas takes place for a longer time period and not for each frame to be displayed. Therefore, the division of the display areas into the respective display areas stays the same at least for a few seconds, preferably several minutes or even hours.

A further advantageous embodiment of the display device according to the invention also provides that the control unit is set up to receive commands for controlling the pixel elements and/or light elements from an external content source, wherein the commands contain the image content to be played back and define the division of the display surface into the display areas. The source content can be connected to the display device by a cable or wirelessly. For this purpose, all common connection techniques are eligible. Both the image content to be displayed, as well as the division of the display surface into the display areas and the respective brightness values for the respective display areas are received by the content source. This simplifies the construction of the display device according to the invention, as therefore only one content source is required in order to inform the display device which image content is to be displayed and how the display surface is to be divided into display areas.

It is preferred that the control unit is set up to receive the image content to be played back and the definition of the division of the display surface via the same data line. This further simplifies the design of the display device according to the invention. So, only one data line is necessary to transmit the corresponding information. The image content to be played back and the definition of the division of the display surface are then split into two different data packets. The different data packets can be transmitted temporally in succession via the data line or also simultaneously as a superimposed signal. In a preferred embodiment, the display device according to the invention is integrated into a vehicle. The data line can then be formed by a data bus of the vehicle, for example by the CAN bus.

A further advantageous embodiment of the display device according to the invention also provides that the control unit is set up to provide at least one transition area between two display areas adjacent to each other, wherein the brightness gradually increases in the transition area, wherein the start value and the end value correspond to the respective brightness of the adjacent display areas. This means that the perceptibility of the image content displayed on the display device is further improved and the distraction level for different users is further reduced. Due to the provision of the transition area, it is prevented that there is sudden difference in brightness between the two adjacent display areas at the line of contact. The transition area represents a type of buffer zone or transition zone for the brightness.

If the user views a display area, assigned to them, a corresponding adjacent display area is in the peripheral field of vision of the user. Since there is now a gradual brightness curve rather than a severe brightness edge, the corresponding user barely perceives or does not perceive the adjacent display area. Thus, the user is also less distracted by the further display area and the other brightness in this display area.

The extent of the transition area between two adjacent display areas can be any size. For example, the transition area can have a fixed size, such as a specific number of pixels or a specific wavelength, such as 5 mm. However, the transition area can also be designed in a variable manner depending on the size of a respective display area, so that the transition area is correspondingly larger for larger display areas. If a first display area has a comparatively low brightness, and an adjacent second display area has a comparatively high brightness, the start value corresponds to the low brightness in the first display area for the gradual brightness curve in the transition area at the connection edge to the first display area and the end value at the connection edge to the second display area corresponds to the high brightness of the second display area.

Transition areas can also be provided on an outer edge of a display area. Then, a fixed specified brightness value can be set as an end value for the brightness, in particular complete darkness, i.e., deactivated light elements.

According to a further advantageous embodiment of the display device according to the invention, the control unit is set up to adjust the brightness of all the display areas to a common reference value as a reaction to an error. This represents an emergency measure in order to maintain reliable operation of the display device. Errors can occur due to different causes and in different situations. The display device can, for example, be designed so that the control unit cyclically requests or receives corresponding brightness values or even outputs them itself. If a brightness value is not received or output for a specific display area for such a request, the control unit does not “know” to which brightness value it is to adjust the brightness of the display area. In this case, the brightness of all the display areas is then adjusted to the common reference value. For example, an error can also occur when, due to a transmission error, for example, the control unit cannot correctly read out a corresponding brightness value in a data signal, or the brightness value is missing entirely.

A fixed specified brightness value stored in the control unit in a data memory can be defined as a common reference value. The common reference value can, however, also be adaptive and vary depending on variable parameters.

Therefore, preferably, it is possible for the common reference value to correspond to the brightness of a reference display area. In other words, in the event of an error, the control unit then changes the brightness of all the display areas to the brightness value which is currently set in the reference display area.

It can therefore be possible for the display device to be divided into different display areas, with one display area being particularly relevant, for example because particularly relevant image content is displayed or a particularly relevant user who is performing a particularly relevant activity uses this display area. This display area then represents the reference display area. For example, the reference display area is assigned to a person driving the vehicle.

According to a further advantageous embodiment of the display device according to the invention, when the display surface is divided into more than two display areas, the control unit is set up, after receiving a command to adjust the brightness of all the display areas to a uniform target value, to gradually adjust the brightness of the display areas to the target value successively depending on the difference from the target value. The target value can be any value or also correspond to the common reference value already explained above. The target value can also correspond to a current brightness setting of a display area.

In general, there are different possibilities for how the brightness of the different display areas can be changed. For example, the brightness can suddenly jump. All display areas could suddenly jump to the target value brightness. However, this is distracting and interfering. A gradual brightness change, i.e., a continual or stepped brightness change, is preferred. In this case, all the display areas could change their brightness simultaneously. The change in brightness could either take place such that each display area is adjusted with the same brightness change, so that the respective display areas reach the target value at different time points. However, the change in brightness could also take place such that the display areas are adjusted at different speeds, so that the display areas all reach the target value simultaneously. Taking into consideration the difference in the brightness between a respective display area and the target value, a particularly interference-free brightness change for the users of the display device can be achieved.

The command to set the brightness of all the display areas to the uniform target value can both be output by the control unit itself or also be obtained from outside the display device, for example from the content source.

For example, the brightness of a first display area is first changed, then that of a second display area and then that of a third display area. The choice as to which display area is changed in brightness first depends on the difference from the target value. This means that the display area of which the brightness is the furthest from the target value is changed first, followed by the display area for which the difference from the target value has the next largest deviation, etc. “In succession” means the starting point at which the brightness change is begun. The brightness change of a display area does not necessarily have to have reached the target value before the brightness of the next display area is changed. Several display areas can therefore also be changed in brightness simultaneously, although the brightness change is begun at different time points.

Therefore, it is preferred that the control unit is set up to first change the brightness of the display area, the value of which has the largest difference from the target value, and when the brightness difference of the display area with the next largest deviation is reached, to change the brightness of the display areas together until all display areas have adopted the target value, wherein the control unit only begins to change the brightness of a display area with a smaller difference from the target value when the display areas, the brightness of which has already changed, reach the respective brightness of the display area with the smaller difference. This means that a less distracting method for changing the brightness of the display areas is provided. Additionally, all display areas reach the target value of brightness simultaneously.

In particular, in this case, the brightness change for each display area takes place with the same gradient, i.e., the same changed brightness level per unit of time.

A vehicle according to the invention comprises a display device described above. The vehicle may be any vehicle such as a car, lorry, van, bus or similar. It may also be a rail vehicle, water vessel or aircraft. Particularly preferably, the content source is a part of the vehicle. For example, the content source can be formed by a vehicle-internal computing unit. For example, this computing unit may be the control device of a vehicle subsystem or also a central on-board computer or similar. The vehicle can have one or more display devices according to the invention. The display device can be arranged at any point in the vehicle.

Preferably, the display device is integrated into the dashboard and extends over the dashboard continuously from the driver's side to the front passenger's side in the direction of the vehicle transverse axis, wherein the display surface is divided into at least three display areas, and wherein, in the direction of the vehicle longitudinal axis, a first display area is provided in front of the driver's seat, a second display area is provided in front of the front passenger's seat, and, in the direction of the vehicle transverse axis, a third display area is provided between the first and second display area. The first display area can thus serve to function as an instrument cluster. The second display area can be used by the front passenger to consume media content, such as film, videos, music or similar. The third display area can be used to provide the functionality of the head unit. In the third display area, information relevant for the journey can be displayed, for example vehicle navigation and operating elements for operating the infotainment system are displayed. Such a design of the display device is also referred to as a pillar-to-pillar display. It is therefore a display that is continuous over the entire vehicle width. In this context, a display area is also referred to as a so-called “content zone”. Here, “integrated” means that the display device can be embedded in the dashboard or can be joined to the dashboard and can protrude from the latter.

According to a further advantageous embodiment of the vehicle, the latter has presence determination means and a control device, wherein the control device is set up to detect, by reading out sensor data of the presence determination means, whether and on which vehicle seat a vehicle occupant is present and, depending on this, to change a depiction of adjusting means to adjust the brightness of the display areas inside the display surface and/or to automatically change the brightness of at least one display area. Different sensors can function as presence determination means, such as interior cameras, a radar sensor recording the passenger compartment, touch-sensitive seat occupancy sensors, and similar. The automatic adaptation of the depiction of the adjusting means enables the vehicle occupants to change the brightness of the display areas even faster and more reliably. If no vehicle occupant is in a specific vehicle seat, the brightness on the display area assigned to the free vehicle seat cannot be adjusted. The corresponding adjusting means is then displayed on a display area assigned to a vehicle seat on which a vehicle occupant is present. In the case of division of the display surface into three display areas, as explained above, three slider controllers for changing the brightness of a respective display area can be displayed in the third display area in the middle of the display device. For example, the person driving the vehicle can reach and operate the respective slider controller quickly and simply. In contrast, if a front passenger is also located in the vehicle, the slider controller for adjusting the brightness of the second display area could instead be displayed only in the second display area. The person driving the vehicle can then assign the slider controller displayed in the third display area to the respective display areas more quickly and simply.

Preferably, the control device is set up to automatically lower the brightness of a display area assigned to a front passenger seat when the passenger seat is free or to deactivate the lighting in this display area entirely. This means that the brightness of the display area irrelevant to the person driving the vehicle is automatically reduced. Therefore, on the one hand, the person driving the vehicle is less distracted by the display area assigned to the front passenger and additionally the driver does not have to give any attention to manually adjusting the brightness of this display area. This means that safety on the road can be further improved, as the person driving the vehicle can be cognitively more focused on the driving process.

Further advantageous embodiments of the display device according to the invention and of the vehicle result from the exemplary embodiments which are described in more detail below with reference to the figures.

### BRIEF DESCRIPTION OF THE DRAWING FIGURES

The figures schematically show:

FIG. 1 a plan view of a display device according to the invention in three different display states;

FIG. 2 a plan view of a display device according to the invention in a further display state;

FIG. 3 a signal path of data which is read in by the display device according to the invention;

FIG. 4 a plan view of the display device according to the invention having a transition zone between two adjacent display areas; and

FIG. 5 a brightness diagram, showing the brightness of three display areas at three different time points during brightness adjustment according to one embodiment according to the invention.

### DETAILED DESCRIPTION

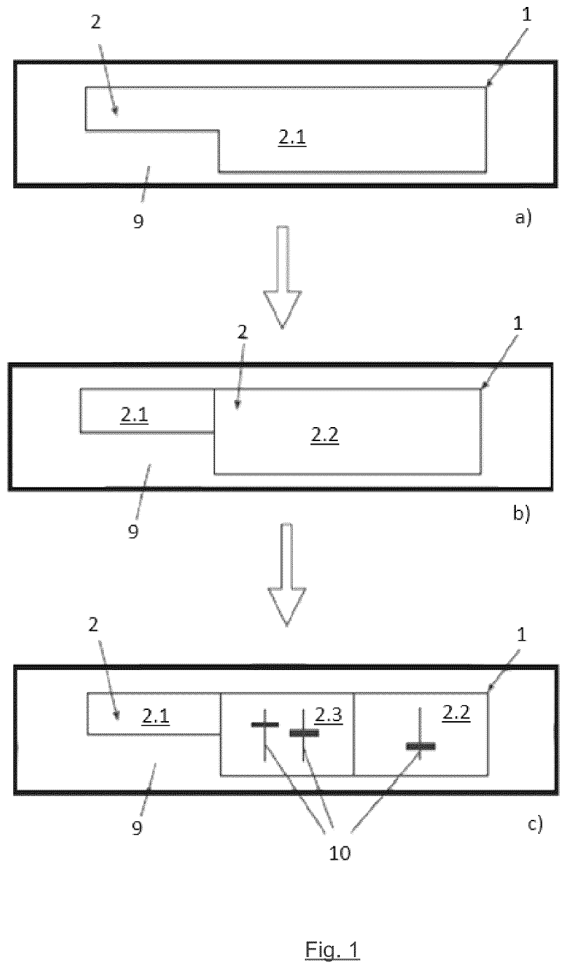

FIG. 1 shows a plan view of a display device 1 according to the invention. The display device 1 is characterized in that a display surface 2 can be divided into at least two separate display areas 2.1, 2.2, wherein the brightness of each of the display areas 2.1, 2.2 can be individually adjusted. For this purpose, the display device 1 comprises a control unit 3, shown in FIG. 3, to control pixel elements and light elements. The display device 1 is particularly preferably integrated into a vehicle, for example, embedded or at least connected in or to the dashboard 9 of the vehicle. The display device 1 can extend over the entire vehicle width so that an individual display area can be assigned at least to the driver and the front passenger.

FIG. 1 shows the display device 1 at three different time points or in three different display states. In FIG. 1a), the display surface 2 forms only one single display area 2.1. This means that the same brightness is set for two or more separate display areas. In FIG. 1b), division of the display surface 2 into a first display area 2.1 and a second display area 2.2 takes place. The screen brightness therefore deviates between the display areas 2.1 and 2.2. By contrast, in FIG. 1c), the display surface 2 is divided into three display areas 2.1, 2.2 and 2.3. The division of the display surface 2 can be adapted at any time by the control unit 3. In this case, the size, shape and positioning of the display areas can be varied. The display device 1 according to the invention thus enables a particularly flexible design of image content to be displayed, in complete contrast to using multiple individual displays.

FIG. 1c) shows a particularly advantageous embodiment, in which the first display area 2.1 is arranged in the vehicle from a viewing direction in front of a person driving the vehicle in the vehicle, for example to form an instrument cluster. The second display area 2.2 is arranged, from a viewing direction, in front of the front passenger. Thus, on the second display area 2.2, the front passenger can, for example, watch films, surf the internet, view photos, make a video call or similar. The third display area 2.3, which can be used to display information relating to the vehicle infotainment system, vehicle navigation or similar, is located between the two display areas 2.1 and 2.2. Each of these display areas 2.1, 2.2 and 2.3 can have an individual brightness. For example, a comparatively low brightness can be set for the display areas 2.1 and 2.3, in order to not excessively distract the person driving the vehicle from the task of driving.

As the second display area 2.2 is comparatively far removed from the person driving the vehicle, here a higher brightness can be set, which facilitates viewing for the front passenger.

In FIG. 1c), several slider controllers 10 are also shown. In the third display area 2.3, two slider controllers are shown, with which the driver and front passenger can change the brightness of the first and third display area 2.1, 2.3. The adjustment of the brightness of the second display area 2.2 is irrelevant for the driver. Therefore, the corresponding slider controller 10 is exclusively shown in the second display area 2.2 and can be operated comfortably by the front passenger. If there is no front passenger, this slider controller 10 can also be displaced into the third display area 2.3, so that only the driver can change the brightness of the third display area 2.3.

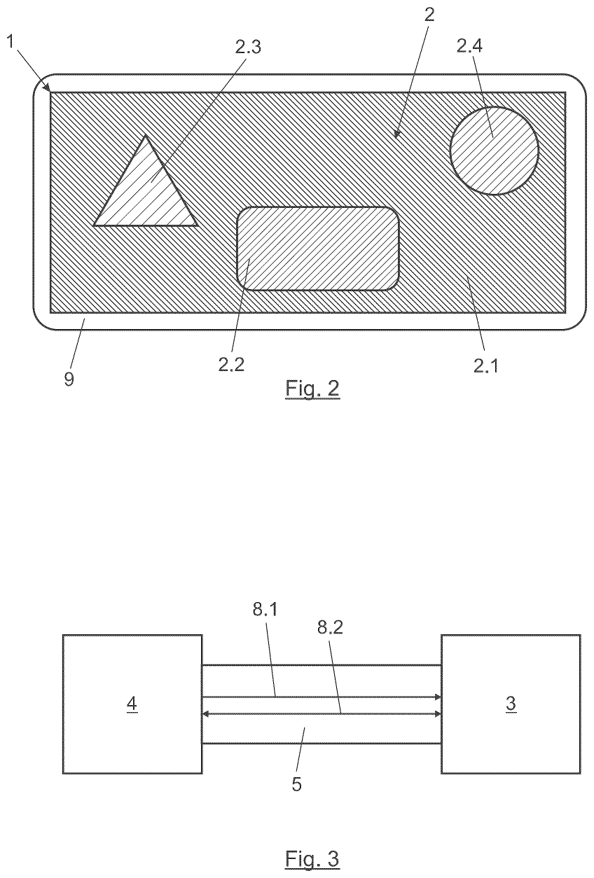

FIG. 2 shows a further possible division of the display surface 2. The embodiments shown here are only to be understood by way of example. The display areas 2.1 to 2.4 can differ in size, shape and position in the display surface 2. All possible shapes are eligible, such as, for example, circular shapes, elliptical shapes, quadratic or rectangular shapes, also with rounded edges, or any polygonal shapes, such as a triangular shape, hexagonal shape, star shape or similar. Each display area 2.1 to 2.4 is demarcated from the respective other display areas 2.1 to 2.4. There are no overlapping display areas. A display area 2.2, 2.3, 2.4 can however be completely enclosed by another display area 2.1.

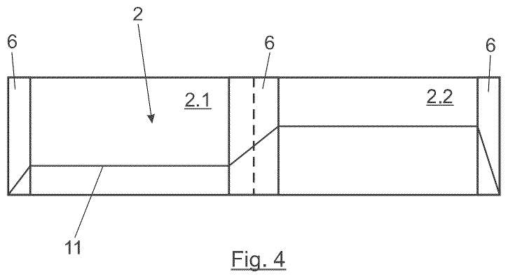

Commands to control the pixel elements and light elements can be initiated not only by the control unit 3, but the control unit 3 can also receive corresponding signals from an external source. This is illustrated in FIG. 3. The control unit 3 is connected to a content source 4 via a data line 5. The data line 5 can have one, or as represented in FIG. 3, two signal paths 8.1 and 8.2. The signal paths 8.1 and 8.2 may be designed logically united or, as shown, logically separate. A video stream containing the image content to be shown is transmitted over the first signal path 8.1. Control signals or commands, which inform the control unit 3 how the display surface 2 is to be divided and which brightnesses are to be assigned to a respective display area 2.1 to 2.4, are transmitted over the second signal path 8.2. The underlying data structure can be designed so that a first data packet describes the division of the display surface 2. A corresponding data packet is divided, for example, depending on the display areas 2.1 to 2.4. Origin coordinates, for example described by a Cartesian XY-coordinate system, for each display area are specified on the display surface 2. Width and height of the respective display area are also specified. In addition, widths for transition areas 6 shown in FIG. 4 can be contained in the data packet. Then the brightness values for each display area are transmitted in a separate data packet.

The control unit 3 can also send information, for example feedback, to the content source 4. The content source 4 can then adapt its behavior.

FIG. 4 shows a display surface 2 divided into two display areas 2.1 and 2.2. A transition area 6 is provided between the two display areas 2.1 and 2.2. Similarly, transition areas 6 can be provided at the respective ends of the display areas 2.1 and 2.2. In FIG. 4, transition areas 6 are shown only on the left and right ends, but not on the upper and lower edges, which would generally be possible, however.

In FIG. 4, in each case one brightness curve 11 is also shown in the display areas 2.1 and 2.2 and the transition areas 6, wherein the height of the curve corresponds to the respective brightness value. As can be seen, the brightness is constant in the display area 2.1 and comparatively low. In the second display area 2.2, the brightness is similarly constant, but higher. In the transition areas 6, the brightness follows a curve and thus the brightness continuously changes over the distance. Therefore, start and end values in the transition area 6 located between the display areas 2.1 and 2.2 correspond to the respective brightness values of the display areas 2.1 and 2.2. The brightness falls to a value of zero, dark, in the edge area. However, it would also be possible to reproduce a residual brightness in the edge region, i.e., to not turn off the light elements completely.

In FIG. 4, the separating line is symbolized between the display areas 2.1 and 2.2 by a dashed line. The transition area 6 is thus identical in size for each of the display areas 2.1 and 2.2. However, it would also be possible for the part of the transition area 6 that is assigned to a specific display area, for example assigned to the first display area 2.1, to be larger than or smaller than the part assigned to the other display area 2.2.

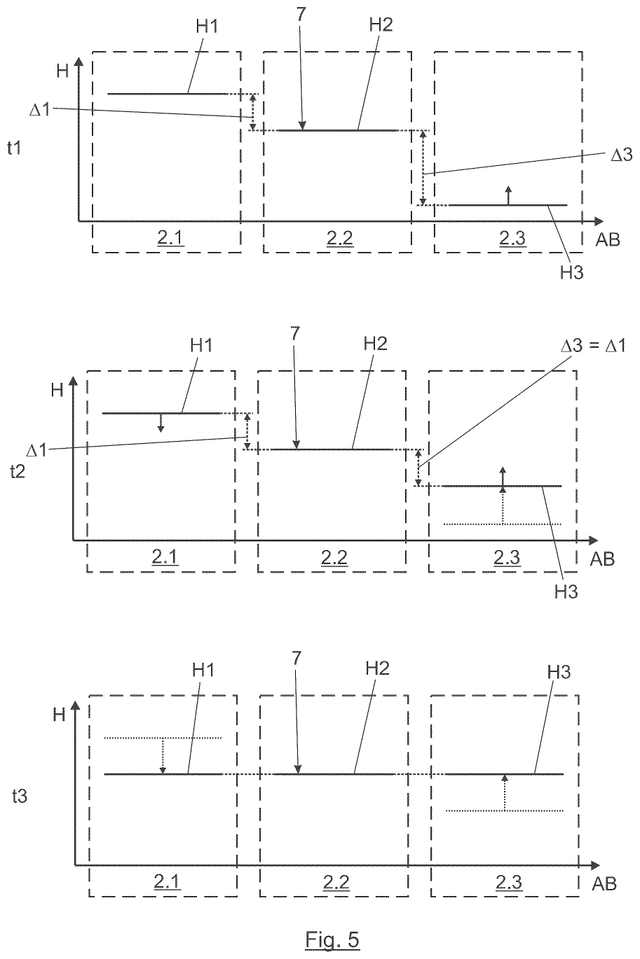

FIG. 5 shows a brightness diagram, showing the brightness setting selected for three display areas AB during a brightness adjustment, according to a preferred embodiment variant according to the invention.

A function can be provided to set the brightnesses H of the different display areas AB, here a first, second, and third display area 2.1, 2.2, 2.3, at a common target value 7. In the exemplary embodiment shown in FIG. 5, the target value 7 corresponds to the brightness H2 of the second display area 2.2. In this case, the target value 7 could form a reference value of the brightness of a reference display area. In general, however, any high target value 7 could be selected. More than three, for example four, five or even more display areas AB could have their brightness H changed.

In general, it would be conceivable to simultaneously change the brightness H suddenly or gradually for all display areas AB. However, this is interfering and distracting. To change the brightness H in a particularly uniform, non-distracting and thus particularly safe way, the brightness change takes place depending on the differences 41 and 43 of the respective brightnesses H1, H3 from the target value 7. At time point t1, the brightness H3 of the display area 2.3, which has the largest difference 43 from the target value 7, begins to be changed first.

If the brightness H3 of the third display area 2.3 reaches the magnitude of the difference 41 at time point t2, the brightness H1 of the first display area 2.1 begins to be changed simultaneously.

The two brightnesses H1 and H3 will continue to be changed until the target value 7 is reached at the same time. This takes place at time point t3.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-14. (canceled)

15. A display device comprising:
a display surface;
a plurality of pixel elements arranged inside the display surface;
a plurality of light elements arranged inside the display surface, wherein the plurality of light elements are arranged behind the plurality of pixel elements from a viewing direction towards the display surface and are configured backlight the plurality of pixel elements or the plurality of light elements are formed by the plurality of pixel elements; and
a control unit configured to control the plurality of pixel elements and the plurality of light elements by dividing the display surface into at least two separate display areas and by individually changing a brightness of the at least two separate display areas by individually controlling each of the plurality of light elements so that the at least two separate display areas have different brightnesses.

16. The display device of claim 15, wherein the control unit is configured to distribute the at least two separate display areas on the display surface independently of image content played back on the display surface.

17. The display device of claim 15, wherein the control unit is configured to change a number or distribution of the at least separate two display areas.

18. The display device of claim 15, wherein the control unit is configured to receive commands to control the plurality of pixel elements or the plurality of light elements from an external content source, wherein the commands contain image content to be played back and define a division of the display surface into the at least two separate display areas.

19. The display device of claim 18, wherein the control unit is configured to receive the image content to be played back and a definition of the division of the display surface via a same data line.

20. The display device of claim 15, wherein the control unit is configured to provide at least one transition area between the at least two separate display areas, which are adjacent to each other, wherein a brightness gradually increases in the at least one transition area, wherein a start value and an end value of the gradually increasing brightness correspond to a respective brightness of an adjacent one of the at least two separate display areas.

21. The display device of claim 15, wherein the control unit is configured to adjust the brightness of all of the at least two display areas to a common reference value as a reaction to an error.

22. The display device of claim 21, wherein the common reference value corresponds to a brightness of a reference display area.

23. The display device of claim 15, wherein when the at least separate two display areas comprises at least three display areas, wherein the control unit configured to, after receiving a command to adjust the brightness of all of the at least three display areas to a uniform target value, to gradually adjust the brightness of the at least three display areas to the uniform target value successively depending on a difference from the uniform target value.

24. The display device of claim 23, wherein the control unit is configured to
first change the brightness of one of the at least three display areas to a value having a difference to the target value, and,
when a brightness difference of the at least three display areas with a next largest deviation is reached, to change the brightness of the at least three display areas together until all of the at least three display areas reach the target value,
only begin to change the brightness of a display area of the at least three display areas with a smaller difference to the target value when the at least three display areas having a changed brightness reach the respective brightness of the display area with the smaller difference.

25. A vehicle comprising:
a display device comprising
a display surface;
a plurality of pixel elements arranged inside the display surface;
a plurality of light elements arranged inside the display surface, wherein the plurality of light elements are arranged behind the plurality of pixel elements from a viewing direction towards the display surface and are configured backlight the plurality of pixel elements or the plurality of light elements are formed by the plurality of pixel elements; and
a control unit configured to control the plurality of pixel elements and the plurality of light elements by dividing the display surface into at least two separate display areas and by individually changing a brightness of the at least two separate display areas by individually controlling each of the plurality of light elements.

26. The vehicle of claim 25, further comprising:
a dashboard, wherein the display device is integrated into the dashboard and extends over the dashboard continuously from a driver's side of the dashboard to a front passenger side of the dashboard in a direction of a vehicle transverse axis,
wherein the at least separate two display areas comprise at least three display areas, and
wherein, in a direction of a vehicle longitudinal axis, a first display area is provided in front of a driver seat, a second display area is provided in front of a front passenger seat and, in the direction of the vehicle transverse axis, a third display area is provided between the first and second display area.

27. The vehicle of claim 26, further comprising:
presence determination means; and
a control device configured to detect, by reading out sensor data from the presence determination means, whether and on which vehicle seat a vehicle occupant is present and, depending on whether and on which of the vehicle seats the vehicle occupant(s) are present, to change a depiction of adjusting means to adjust the brightness of the at least three display areas inside the display surface or to automatically change the brightness of at least one of the at least three display areas.

28. The vehicle of claim 27, wherein the control device is configured to automatically lower the brightness of a display area of the at least two separate display areas, assigned to a front passenger seat when the front passenger seat is free or to deactivate lighting in the display area of the at least separate two display areas entirely.

29. A method comprising:
receiving, by a control unit, first and second image contents;
displaying, by a display device coupled to the control unit, the first and second image contents in two separate display areas, wherein the display device comprises a display surface, a plurality of pixel elements arranged inside the display surface, and a plurality of light elements arranged inside the display surface, wherein the plurality of light elements are arranged behind the plurality of pixel elements from a viewing direction towards the display surface and are configured backlight the plurality of pixel elements or the plurality of light elements are formed by the plurality of pixel elements; and
individually changing, by the control unit, by individually changing a brightness of the two separate display areas by individually controlling each of the plurality of light elements so that the two separate display areas have different brightnesses.
